(19) United States
(12) Patent Application Publication
(10) Pub. No.: US 2009/0211984 A1
(43) Pub. Date: Aug. 27, 2009

(54) Salt tank monitor

(76) Inventor: Bret L. Petty, Avon, IN (US)

Correspondence Address: KRIEG DEVAULT LLP, ONE INDIANA SQUARE, SUITE 2800, INDIANAPOLIS, IN, 46204-2079, US

(21) Appl. No.: 12/380,037

(22) Filed: Feb. 23, 2009

Related U.S. Application Data
(60) Provisional application No. 61/066,649, filed on Feb. 22, 2008.

(51) Int. Cl. C02F 1/68; C02F 103/00; B21D 51/16; G01L 7/00; G01F 23/00

(52) U.S. Cl. 210/741; 210/86; 29/890.09; 73/700; 73/290 R

(57) ABSTRACT

A system and method to determine a salt level within a brine tank. In one form a tube is disposed vertically within a brine tank and includes an interior portion between an open bottom end and a closed upper end. When water level in the tank rises above the bottom of the tube, a pressure detector detects an increase in air pressure within the tube. The pressure detector can take the form of a pressure switch. The switch may be in a normally open condition when the water level is below the bottom of the tube and is closed when the water is above the bottom of the tube. A device can be used to indicate a “Low Salt” or “Call for Service” condition depending on the sequence of the pressure detector during a regeneration cycle.

### CROSS REFERENCE TO RELATED APPLICATIONS

This application claims the benefit of U.S. Provisional Application No. 61/066,649, filed Feb. 22, 2008, which is hereby incorporated by reference in its entirety.

### TECHNICAL FIELD

The technical field relates generally to water softeners, and in a particular aspect relates to monitors for brine tanks.

### BACKGROUND

Some present approaches to water softening suffer from a variety of drawbacks, limitations, disadvantages and problems including those respecting determining when to refill a salt reservoir and others. There is a need for the unique and inventive water softening monitoring apparatuses, systems and methods disclosed herein.

### SUMMARY

One embodiment of the present invention is a unique salt monitor. Other embodiments include apparatuses, systems, devices, hardware, methods, and combinations for monitoring a salt quantity within a salt reservoir. Further embodiments, forms, features, aspects, benefits, and advantages of the present application shall become apparent from the description and figures provided herewith.

### BRIEF DESCRIPTION OF THE FIGURES

FIG. 1 depicts an embodiment of a softener and brine tank.

FIG. 2 depicts an embodiment of a softener and brine tank.

FIG. 3 depicts an embodiment of a softener and brine tank.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

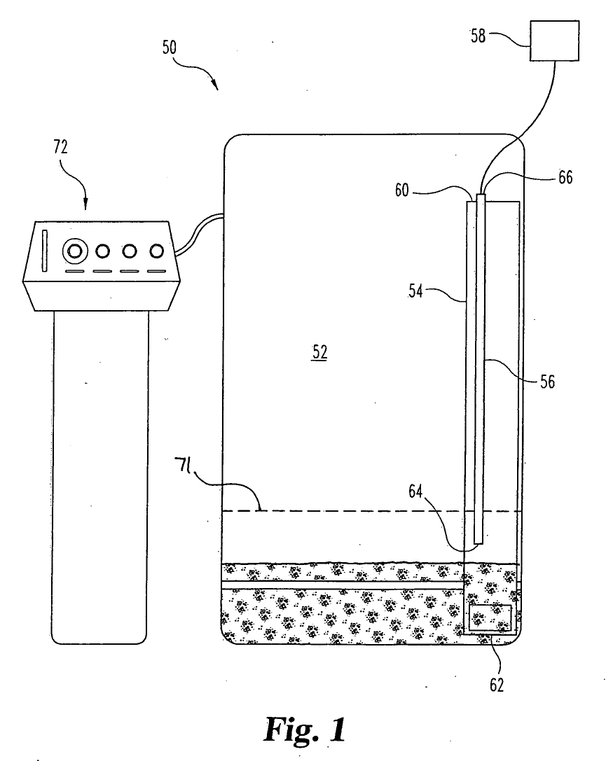

Turning now to FIG. 1, a brine tank 50 that can be integrated into a water softening system is depicted and includes a salt reservoir 52 and a brine well 54. The salt reservoir 52 is used to receive a quantity of salt for use in the water softening system. As used herein, the term “salt” is not limited to sodium chloride but can alternatively and/or additionally include other compounds and/or substances useful in a water softening system. The brine well 54 includes a top end 60 and a bottom end 62, both of which can include openings in communication with the interior of the brine tank 50. The brine tank 50 is structured to receive a solvent, such as but not limited to water, during a regeneration cycle of the water softening system. As the solvent is transferred to and from the brine tank 50 during the regeneration cycle, a brine level within both the salt reservoir 52 and brine well 54 similarly rise and fall. As will be understood, a “brine” is a solution of the solvent and the salt or other substance suitable for a water softening system. A pressure member 56 and a pressure detector 58 are also disposed within the brine tank 50 depicted in FIG. 1.

In one non-limiting form the pressure member 56 includes a lower end 64, and an upper end 66 and extends into the brine well 54. The pressure member 56 can include an interior portion that contains a compressible fluid such as, but not limited to, air. In the illustrative embodiment the lower end 64 includes an opening in flow communication with the interior portion of the pressure member 56 and the interior of the brine tank 50. The location of the opening is set at a reference height within the brine tank 50. The reference height can be related to a minimum level of brine that corresponds to a minimum level of salt, as will be apparent from the discussion below. In other embodiments the opening can be located elsewhere in the pressure member 56. For example, the opening can be included a distance from the lower end 64. For convenience of discussion below, the opening will be referred relative to the lower end 64, and as such may be referred to as the open lower end, but no limitation of the location of the opening is intended by this convenience.

As the brine level rises within the brine well 54 the brine can intrude a distance into the open lower end 64 of the pressure member 56 and compress the compressible fluid trapped inside, thus producing a rise in pressure of the compressible fluid within the pressure member 56. While the brine level within the brine well 54 may continue to rise, the brine inside the pressure member 56 will only rise so far as the compressed compressible fluid will allow, as will be understood by those of skill in the art. In some embodiments the pressure member 56 may be completely sealed, that is, it may have no opening that communicates between the open interior and the brine tank. To set forth just one non-limiting example, the pressure member 56 can be at least partially collapsible so that when the brine level rises the pressure member 56 collapses and a pressure of the compressible fluid increases owing to the decrease in volume of the interior portion. The location at which the pressure member 56 collapses can be set at a reference height within the brine tank 50. In another non-limiting example, the pressure member 56 could take the form of a flexible diaphragm that reacts to an increasing pressure of the brine as it rises above the location of the diaphragm and communicates the increasing pressure to the pressure detector 58. The diaphragm can be at a variety of locations, including at the end of the pressure member 56 or inside of it, to set forth just two non-limiting examples. Other forms of the pressure member 56 are contemplated herein.

The pressure detector 58 is operable to detect a pressure of the compressible fluid. In one form the pressure detector 58 is a pressure switch located above a brine level of the brine tank 50 and senses a pressure of the compressible fluid within the pressure member 56. In one form the switch can be operable to indicate an open condition when a brine level within the brine well 54 is below a reference level, such as the open lower end 64, and a closed condition when the brine level is above the reference level, all by virtue of the increase in air pressure within the pressure member 56, as described above. The closed condition can occur at various levels at or above the reference level. For example, some embodiments of the pressure detector 58 can have a tolerance such that the closed condition can occur at a range of levels. In some embodiments, the relationship can be reversed such that the pressure detector 58 is closed when the brine level is below the reference level and open when the brine level is above the reference level. The reference level can be any level within the brine tank 50 that is used to measure an increase in pressure as the level of brine rises and falls. In those forms where the pressure detector 58 is a pressure switch, the pressure detector 58 can provide any variety of outputs indicative of an “open” condition and a “closed” condition. To set forth just two non-limiting examples, the pressure detector 58 can provide a DC or AC signal indicative of one or both of the conditions. Alternatively and/or additionally, the pressure detector 58 can be operable to measure a pressure of the compressible fluid within the pressure member 56. In these embodiments, the pressure detector 58 can measure pressure anywhere within the pressure member 56, whether near the upper end 66 or near the lower end 64, to set forth just two non-limiting examples. For example, any variety of pressure gauges, transducers or other pressure sensing devices can be used. As will be appreciated, the pressure detector 58 can detect the working fluid pressure by any variety of techniques such as changes in the level of a column of hydrostatic measuring fluid, and/or changes in electrical properties such as resistance, voltage, or current, to set forth just a few non-limiting examples.

In some forms the pressure member 56 and the pressure detector 58 can be formed into a device that does not require use of an elongated pressure member of the illustrative embodiment. For example, a pressure transducer could be used having a housing that is not elongate. The pressure transducer can include an internal cavity and a pressure responsive structure that responds to changing pressures. The internal cavity can have a reference pressure or can be in fluid communication with the interior of the brine tank 50 or in fluid communication with the ambient environment, to set forth just a few non-limiting examples. In some forms the pressure member 56 and/or pressure detector 58 can be formed to be submerged beneath a level of the brine during a regeneration cycle. Other configurations and integrations are also contemplated herein.

In some embodiments the pressure detector 58 can be connected to a device such as a water softener 72 which can be operable to receive signals from the pressure detector 58 and indicate such signals to a user. Devices other than the water softener 72 can also be used. The device can be a mechanical or electrical device and can be operable to display a condition within the brine tank 50 using sensory signals such as aural or visual.

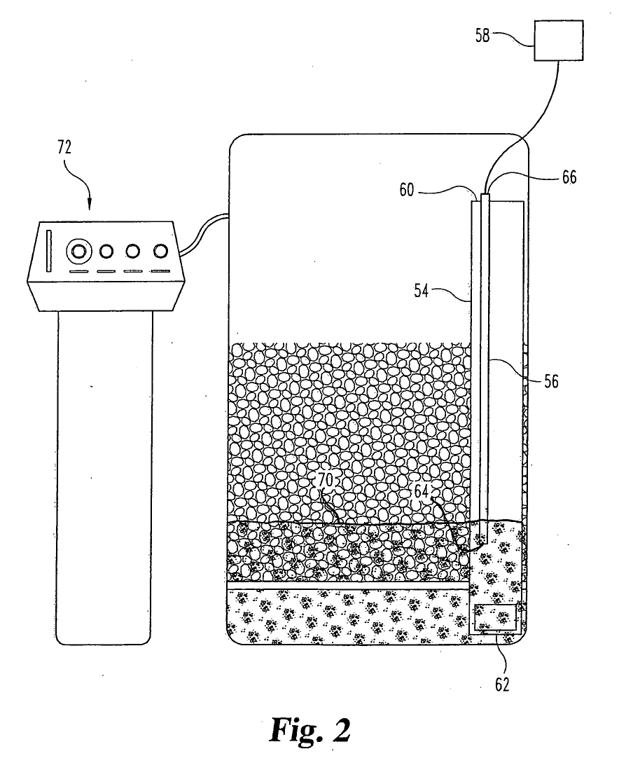

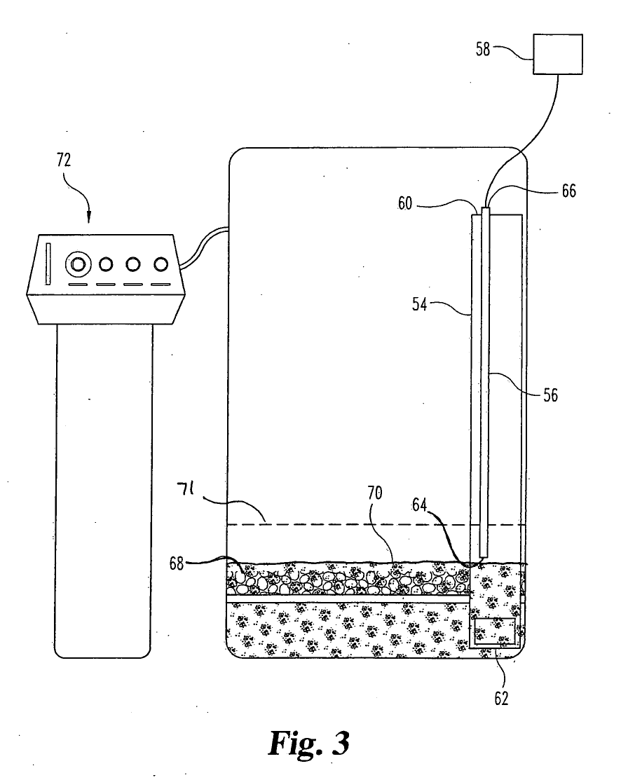

FIGS. 1-3 depict a progression of some portion of a regeneration cycle within the brine tank 50. The level of brine required to regenerate a softener is at its lowest level when there is an absence of salt in the brine tank 50. This is the minimum level of brine (or simply water if no solute is present) and may be seen in FIG. 1. When salt is added to the salt reservoir 52 the brine is displaced causing a rise in the brine level as can be seen in FIG. 2. The brine will continue to rise if salt is continued to be added until the level of salt equals or exceeds the level of water. Depending on the size and quantity of the salt used, whether block salt or particle salt, the maximum level of brine, or maximum brine level, may vary. For convenience of reference only, the maximum brine level can be noted as a dashed line and is depicted as reference numeral 71 in FIG. 1. The brine level inside the brine well 54 can be slightly higher than the maximum level in the salt reservoir 52 shown in FIG. 2.

In one embodiment of the present application, a regeneration cycle can be described as follows. During the water refill portion of the regeneration cycle with an adequate amount of salt in the brine tank 50, the brine rises above the open lower end 64 of the pressure member 56, and in some embodiments compresses the compressible fluid in the pressure member 56. In an embodiment where the pressure detector 58 is a low pressure switch, the compression will engage the switch, and thus close a switch circuit. When the brine level drops in the brine draw portion of the regeneration cycle, the switch will open. When the water refills into the brine tank 50 again the switch will close. In other embodiments a pressure could be sensed as opposed to a switch opening and closing, as will be understood by those skilled in the art. If a pressure is sensed, a reference pressure can be used to determine when the brine level has fallen and risen based upon the measured pressures relative to the reference pressure.

Once an amount of salt remaining in the tank falls below the maximum brine level 71 at the completion of the regeneration cycle, the resulting brine level 70 will decline with each subsequent regeneration cycle as more and more salt is used. It will be appreciated, however, that the maximum brine level 71 can be the same as the resulting brine level 70 at least until the salt remaining in the tank falls below the maximum brine level 71. Eventually there will not be enough salt remaining to displace the brine enough to reach the reference location of the pressure member 56. With proper placement of the pressure member 56 and/or pressure detector 58, the switch will not close because the brine level has not risen a sufficient level to pressurize the compressible fluid. This event could signal a “Low Salt” condition. Once a sufficient amount of salt is added to the salt reservoir 52, the resulting brine level 70 would rise again thus pressurizing the compressible fluid. The “Low Salt” condition could then be deleted and/or the indication of “Low Salt” could be extinguished. The “Low Salt” condition can be displayed using the sensory signals above or other types of signaling

If a softener 72 fails to draw brine during regeneration the pressure switch would fail to open during the regeneration cycle. Such an event can occur if a mechanical failure were present somewhere in the water softening system. This event could generate a signal representative of a “Call For Service” condition. The “Call For Service” condition can remain until the system is corrected allowing it to draw brine which would open the switch. The condition could be cleared manually or through other techniques.

Three operating conditions can be defined, but others may also be possible. The three conditions below are described relative to a pressure switch, but it will be understood that other types of pressure sensing mechanisms can be used, such as, but not limited to, pressure measurement sensors such as transducers mentioned above. Also, the three conditions are described relative to a pressure member having an open lower end, but as was mentioned above various other forms of the pressure member are contemplated. Variations of the conditions below given the scope of the description above will be appreciated by those of skill in the art.

(1) Normal Condition—(a) The pressure detector 58, in the form of a switch, is closed at the beginning of the regeneration cycle because the brine level 70 is above the open lower end 64; (b) the pressure detector 58 opens during the regeneration cycle when the brine level 70 falls below the open lower end 64; and (c) the pressure detector 58 is returned to closed at the completion of the cycle when brine level 70 returns above the open lower end 64.

(2) “Low Salt” Condition—(a) The pressure detector 58 is closed at the beginning of the regeneration cycle because the brine level 70 is above the open lower end 64, but could also already be open if a previous regeneration cycle completed with a resulting brine level 70 below the reference level; (b) the pressure detector 58 opens, or remains open if the completion of the previous regeneration cycle resulted in an open condition, during the cycle when the brine level 70 falls below the open lower end 64; and (c) the pressure detector 58 remains open at completion of cycle because the brine level 70 fails to return above the open lower end 64.

(3) “Call for Service” Condition—(a) the pressure detector 58 is closed when regeneration begins; (b) the pressure detector 58 remains closed during regeneration; and (c) the pressure detector 58 remains closed at the completion of regeneration. In other words, the switch fails to open during regeneration cycle. Another embodiment of the “Call for Service” condition is described hereinabove.

In another aspect of the application, protection of the product will apply to the inverse of a normally open switch. A normally closed switch could be used with the inverse relationship applied.

Yet another aspect of the present application includes a brine tank having a salt reservoir and a brine well. A tube is disposed vertically within the brine well and includes a sealed upper end and an open lower end. A pressure switch detects, senses, or otherwise monitors an air pressure within the tube. The pressure switch measures internal ambient air pressure until the brine level rises and reaches the open lower end of the tube. As the brine level continues to rise, some amount of brine will intrude into the interior of the tube causing a rise in air pressure. The pressure switch is normally open when the brine is below the open lower end of the tube, and is closed when brine rises up to and above the open lower end. During a regeneration cycle, the brine level inside the brine well will rise above the bottom of the open lower end of the tube when a sufficient amount of salt remains in the salt reservoir during a water refill. In this situation the pressure switch will close during the water refill process. In some instances, however, the brine level will fail to rise above the open lower end of the tube when an insufficient amount of salt remains in the salt reservoir during a water refill. In this situation the pressure switch will remain open during the water refill process. The salt monitor described herein can therefore be used to indicate when a sufficient quantity of salt remains in the salt reservoir by inspection of the pressure level switch, whether it remains in an open condition or closed condition after the water refill. In addition, if a water softener fails to draw brine during the regeneration cycle, then a condition may be set and remain until the system is corrected.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An apparatus comprising:
a pressurizable member operable to be disposed within a brine tank and having an interior operable to contain a working fluid that becomes relatively pressurized when a brine level within the brine tank rises above a reference location of the pressurizable member; and
a pressure responsive device operable to detect a pressure condition within the pressurizable member as a result of the brine level rising above the reference location of the pressurizable member.

2. The apparatus of claim 1 wherein the pressurizable member includes an external opening in communication with the interior of the pressurizable member.

3. The apparatus of claim 1, wherein the pressure responsive device is a pressure switch operable to provide an indication when the pressure condition exceeds a reference pressure.

4. The apparatus of claim 3, wherein the indication represents the change of an electrical circuit between an open condition and a closed condition.

5. The apparatus of claim 1, wherein the pressure responsive device is a pressure measuring device operable to sense a pressure within the pressurizable member and provide a pressure value representative of the pressure.

6. The apparatus of claim 1, which further includes a brine tank and a brine well disposed within the brine tank, the pressurizable member disposed within the brine well.

7. The apparatus of claim 1, which further includes a reservoir operable to receive a brine from the brine tank, the reservoir containing a water softening agent.

8. An apparatus used to indicate whether a sufficient amount of salt remains in the brine tank of a water softening system comprising:
a brine tank fluid pressure mechanism having a cavity and a pressure sensing device and operable to indicate a pressure presence within a brine tank of a water softening system, the pressure presence dependent on a brine level within the brine tank such that when the brine level rises above a reference level the pressure presence changes from a first value to a second value.

9. The apparatus of claim 8, wherein the cavity includes an opening that can be closed by a rise in the brine level.

10. The apparatus of claim 9, wherein the opening allows intrusion of brine into the cavity as the brine level rises above the opening.

11. The apparatus of claim 8, wherein the pressure sensing device is a pressure switch that provides the first value when the brine level is below the reference level and the second value when the brine level is above the reference level, the first value and the second value being discretes.

12. The apparatus of claim 11, wherein the pressure sensing device is coupled with a device operable to receive the first value and second value and to report a low salt level, one of the first value and second value having an electrical current that represents a discrete value.

13. The apparatus of claim 12, wherein the low salt level is reported when after a regeneration cycle the controller fails to receive a second value because the brine level fails to return above the reference level.

14. The apparatus of claim 8, which further includes a salt reservoir and a brine well, the cavity of the brine tank pressure sensing device disposed within the brine well.

15. The apparatus of claim 14, which further includes a water softener coupled with the brine tank and operable to receive brine from the brine tank.

16. An apparatus comprising:
a water softening system brine tank operable to contain a salt reservoir; and
means for determining a deficiency of a salt quantity within the salt reservoir after a regeneration cycle of a water softening system.

17. A method comprising:
installing a pressure device having an internal volume within a brine tank of a water softening system and operable to produce a change in working fluid pressure upon a rising level of brine within the brine tank; and
coupling the pressure device with a pressure sensitive member operable to provide a first indication when the working fluid pressure from the pressure device is above a reference value.

18. The method of claim 17, which further includes locating a reference position of the pressure device at a reference level of the brine tank.

19. The method of claim 18, wherein the locating a reference position includes positioning an air inlet of the pressure device at the reference level.

20. The method of claim 18, wherein the coupling includes placing the pressure sensitive member in flow communication with an interior of the pressure device.

21. The method of claim 18, wherein the pressure sensitive member indicates a low salt condition by indicating a first pressure at the start of a regeneration cycle and indicating a second pressure at the completion of the regeneration cycle.

22. The method of claim 18, wherein the pressure sensitive member indicates a call for service condition by indicating a first pressure throughout a regeneration cycle.

23. The method of claim 18, which further includes connecting the pressure sensitive member with an indicator device operable to receive the indicating from the pressure sensitive member.

24. A method comprising:
detecting a first working fluid pressure within a pressure device installed in the brine tank before the filling of the brine tank;
filling a brine tank of a water softening system with water; and
detecting a second working fluid pressure within the pressure device at least upon completion of the filling the brine tank

25. The apparatus of claim 1, which further includes a brine tank, the pressurizable member disposed within the brine tank.

26. The apparatus of claim 8, which further includes a salt reservoir and a brine well, the cavity of the brine tank pressure sensing device disposed outside of the brine well.
